(19) United States
(12) Patent Application Publication
(10) Pub. No.: US 2009/0289111 A1
(43) Pub. Date: Nov. 26, 2009

(54) System And Method For Providing A Product-Based Coupon Card Account

(76) Inventors: Debbie Motycka, Salem, AL (US); Carole Fallgren, Powder Springs, GA (US); Kathy Heitmueller, Midland, GA (US); Benjamin N. Nwadike, Dalton, GA (US); Allen Parker, Fortson, GA (US); Brad P. Roussel, Atlanta, GA (US); Veronica Stewart, Columbus, GA (US); Kimberly A. Smith, Columbus, GA (US); Evelyn E. Torres, Columbus, GA (US); Chris J. Truelson, Cumming, GA (US)

Correspondence Address: KING & SPALDING, 1180 PEACHTREE STREET , NE, ATLANTA, GA, 30309-3521, US

(21) Appl. No.: 12/470,715

(22) Filed: May 22, 2009

Related U.S. Application Data
(60) Provisional application No. 61/128,560, filed on May 22, 2008.

(51) Int. Cl. G06K 5/00

(52) U.S. Cl. 235/380

(57) ABSTRACT

Providing a product-based coupon account. Specifically, the invention provides systems and methods for providing consumers with a coupon account for receiving an incentive or discount for purchasing a particular product. The consumer is issued a coupon account or coupon card that can be used at a merchant to receive the incentive at the time of purchase of the particular product. The coupon card is scanned at the merchant point of sale and information associated with the transaction including product-level information (e.g., SKU or UPC) and information associated with the coupon card is communicated to a authorization computing system for approval based on this information. The coupon card can be issued for one-time use or can receive updated incentives periodically.

### STATEMENT OF RELATED PATENT APPLICATIONS

This non-provisional patent application claims priority under 35 U.S.C. §119 to U.S. Provisional Patent Application No. 61/128,560, titled Method and System for SKU/UPC Level Processing, filed May 22, 2008. This provisional application is hereby fully incorporated herein by reference.

### FIELD OF THE INVENTION

This invention relates to providing a product-level coupon card account. More particularly, this invention relates to processes and systems that provide for a coupon card account that provides a discount on predetermined products based on a Stock-Keeping Unit (SKU) or Universal Product Code (UPC) identifier of the product.

### BACKGROUND OF THE INVENTION

The use of paper coupons is well known to provide discounts on products based on type of product or manufacturer. In some cases, these coupons are provided to loyal customers of a product or merchant. Typically, a consumer presents the coupon at the time of the transaction at the merchant. The merchant will manually discount the product, based on the coupon's restrictions, i.e., percent discount, expiration date, etc. The merchant will then transmit the coupon to its issuer, for example, the manufacturer. In time, the manufacturer will reconcile the account, and reimburse the merchant for the amount of the coupon. In this conventional method, there is a significant time delay for the merchant to be reimbursed by the manufacturer; there is room for error as the merchant manually reads the coupon and enters the discount; and the coupon is typically only used one time.

In addition to traditional paper coupons, certain vendors have issued coupons in the form of a financial card, herein referred to as a “coupon card.” These coupon cards typically operated on an association network (such as VISA, MASTERCARD, etc.) to automatically provide the discount. However, transactions involving these coupon cards were not approved or declined based on the particular product purchased or merchant used. That is, transactions involving these coupon cards were not approved or declined based on the SKU or UPC identifier associated with a product.

UPC and SKU identifiers are used by merchants and manufacturers to identify products. A UPC identifier typically includes a number and a bar code that is used to identify an individual product. An SKU identifier can include alpha and numeric characters and can be used to universally identify an individual product or can be used to differentiate between a product for sale at one merchant and that same product for sale at a different merchant.

As conventional coupon cards could not provide discounts at the SKU/UPC level of a product, a need exists in the art for a system and method for establishing and processing product-level coupon card accounts.

### SUMMARY OF THE INVENTION

The invention provides systems and methods for providing a product-based coupon account. Specifically, the invention provides systems and methods for providing consumers with a coupon account for receiving an incentive and/or discount for purchasing a particular product.

An aspect of the invention provides a method for providing a product-based coupon account. This method includes the steps of receiving, by a processing platform, a data element including transaction data associated with a transaction, the transaction data including product data associated with a product in the transaction and coupon card data; determining, by an authorization engine, whether the transaction is approved by comparing the data element to information stored in an authorization table; and in response to determining, by the authorization engine, that the transaction is approved, sending an approval message to the merchant indicating that a discount can be applied to the transaction.

Another aspect of the invention provides a system for providing a product-based coupon account. This system includes a computing system communicably coupled to a merchant point of sale. The computing system includes an authorization engine for determining whether a transaction is approved. The communications between the computing system and merchant point of sale includes: receiving a data element, at the computing system, including transaction data associated with a transaction, the transaction data including product data associated with a product in the transaction and coupon card data; and in response to determining, by the authorization engine, that the transaction is approved, sending, by the computing system, an approval message to the merchant point of sale indicating that a discount can be applied to the transaction, wherein the authorization engine determines whether the transaction is approved by comparing the transaction data to information stored in an authorization table.

These and other aspects, features and embodiments of the invention will become apparent to a person of ordinary skill in the art upon consideration of the following detailed description of illustrated embodiments exemplifying the best mode for carrying out the invention as presently perceived.

### BRIEF DESCRIPTION OF THE DRAWINGS

For a more complete understanding of the exemplary embodiments of the present invention and the advantages thereof, reference is now made to the following description, in conjunction with the accompanying figures briefly described below.

FIG. 1 is a block diagram depicting a system architecture for providing a product-based coupon card account in accordance with an exemplary embodiment of the present invention.

FIG. 2 is an overall process flow diagram depicting a method for providing a product-based coupon card account in accordance with an exemplary embodiment of the present invention.

FIG. 3 is a detailed process flow diagram depicting a method for processing transaction data using authorization tables in accordance with an exemplary embodiment of the present invention.

FIG. 4 is a detailed process flow diagram depicting a method for updating a coupon card in accordance with an exemplary embodiment of the present invention.

FIG. 5 is a detailed process flow diagram depicting a method for updating authorization tables in accordance with an exemplary embodiment of the present invention.

### DETAILED DESCRIPTION OF THE EXEMPLARY EMBODIMENTS

The invention provides systems and methods for providing a product-based coupon account. Specifically, the invention provides systems and methods for providing consumers with a coupon account for receiving an incentive or discount for purchasing a particular product. The consumer is issued a coupon account or coupon card that can be used at a merchant point of sale to receive the incentive at the time of purchase of the particular product. The coupon card is scanned at the merchant point of sale and information associated with the transaction including product-level information (e.g., SKU or UPC) and information associated with the coupon card is communicated to a authorization computing system for approval based on this information. The coupon card can be issued for one-time use or can receive updated incentives periodically.

The invention can include one or more computer programs that embody at least a portion of the functions described herein and illustrated in the appended flow charts. However, it should be apparent that there could be many different ways of implementing aspects of the invention in computer programming, and these aspects of the invention should not be construed as limited to any one set of computer program instructions. Further, a skilled programmer would be able to write such computer programs to implement an embodiment of the disclosed invention based on the flow charts and associated description in the application text. Therefore, disclosure of a particular set of program code instructions is not considered necessary for an adequate understanding of how to make and use the invention. The inventive functionality of the claimed computer programs will be explained in more detail in the following description read in conjunction with the figures illustrating the program flow. Further, those skilled in the art will appreciate that one or more of the stages described may be performed by hardware, software, or a combination thereof, as may be embodied in one or more computing systems.

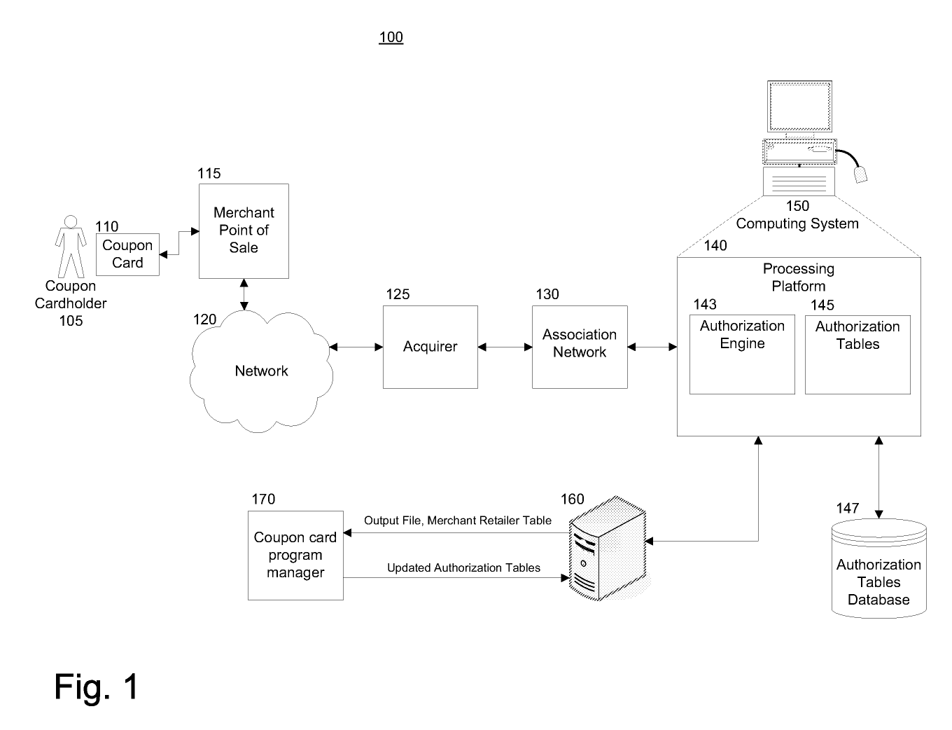

Turning now to the drawings, in which like numerals represent like elements throughout the figures, aspects of the exemplary embodiments will be described in detail. FIG. 1 is a block diagram depicting a system architecture 100 for providing a product-based coupon card account in accordance with an exemplary embodiment of the present invention. Referring to FIG. 1, the system architecture 100 includes a coupon cardholder 105 having a coupon card 110. The coupon cardholder 105 is a consumer or entity, such as a business, that holds a financial account for a coupon card 110. The coupon card 110 is an account that provides a discount or other incentive to the coupon cardholder 105 when the coupon card 110 is used in connection with a transaction involving a purchase of a predetermined product. During such a transaction, the coupon card 110 is used at a merchant point of sale 115. The merchant point of sale 115 is a method or device for capturing information about the transaction, including the product-level data, as well as information about the coupon card 105. Product-level data is used herein to describe any information used to represent a product, including a SKU or UPC code, and may include data for more than one product.

The merchant point of sale 115 is in communication with a network 120. The network 120 is a communications network, such as a telecommunications network, computer network, or the Internet. The network 120 is in communication with an association network 130 by way of an acquirer 125. The association network 130 is the network associated with the card issuer, i.e. an association such as VISA, MASTERCARD, or a retailer such as MACY'S. The association network 130 is in communication with the authorizations computing system 150. The authorizations computing system 150 is a computing system, such as a personal computer, server, or mainframe computer, that is typically run by a card processor and is used to approve or decline the use of the coupon card 110 in connection with a particular transaction. Thus, the information captured by the merchant point of sale 115 can be sent to the authorizations computing system 150 to approve or decline transactions involving the coupon card 110 and the authorizations computing system 150 can then send a message to the merchant point of sale 115 indicating that the coupon card transaction is approved or declined.

The acquirer 125 is an intermediary between the merchant point of sale 115 and the association network 130. Typically, the acquirer 125 receives the information captured by the merchant point of sale 115 by way of the network 120 and provides this information to the association network 130. Similarly, the acquirer 125 receives the message indicating if the coupon card 110 transaction is approved or declined from the association network 130 and provides this message to the merchant point of sale 115. Although this exemplary system 100 includes an acquirer 125, the acquirer 125 is optional, and some merchants (typically larger merchants) can communicate directly with the association network 130. Additionally, some embodiments do not make use of the association network 130 but instead employ a system such as an interactive voice response (IVR) system to provide communications between the merchant point of sale 115 and the authorizations computing system 150.

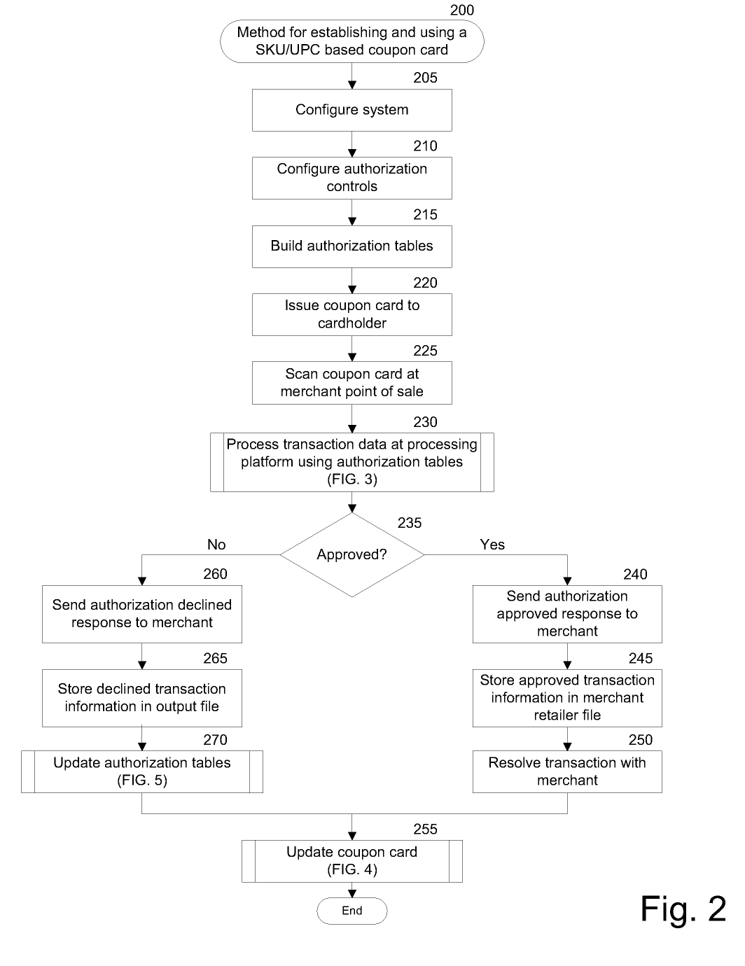

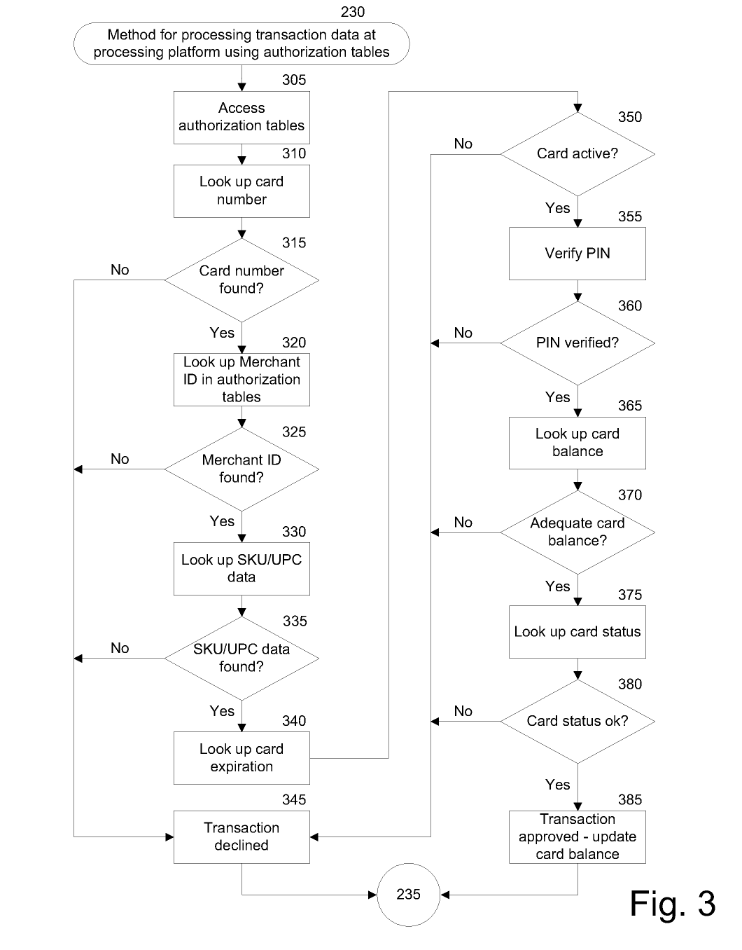

The authorizations computing system 150 includes a processing platform 140, which includes an authorization engine 143 and authorization tables 145. The processing platform 140 is a computing platform that can run computing applications, such as the authorization engine 143. The authorization engine 143 analyzes the data, such as product information and coupon card 110 information, sent by the merchant point of sale 115 during a transaction, and determines whether to approve or decline the transaction. To do so, the authorization engine 143 accesses authorization tables 145, which store information related to the coupon card 110 accounts (coupon card data), merchants having a merchant point of sale 115, and predetermined products for which incentives are given through the coupon card program. Exemplary information contained in authorization tables is listed below in Table 1. The authorization engine 143 compares the data sent by the merchant point of sale 115 to the information in the authorization tables 145 to determine whether the transaction should be approved or declined. The system architecture 100 also includes an authorization tables database 147, which can be stored on or coupled to the authorizations computing system 150, and can store information contained in the authorization tables 145. The analysis and determination processes performed by the authorization engine 143 will be described in more detail herein with reference to FIGS. 2 and 3.

TABLE 1
Exemplary Authorization Table Information

| Coupon Card Data | Merchant Information | Product Information |
|---|---|---|
| Account Number | Name | Product Name |
| Cardholder Name | Address | SKU |
| Cardholder Address | ID Number | UPC |
| Status | | |
| (e.g., active, inactive, | | |
| blocked) | | |
| Balance | | |
| Expiration Date | | |
| Incentive Level | | |
| Personal Identification | | |
| Number (PIN) | | |

The system architecture 100 also includes an administrative computing system 160, such as a server, a group of servers, a mainframe computer, or a personal computer. The administrative computing system 160 includes software and modules for handling the back-end functions of the coupon card account system 100. These back-end functions include building an output table having information associated with transactions that have been declined by the authorization engine 143, building a merchant retailer table having information associated with approved transactions for settlement purposes, and updating the authorization tables 145 based on an updated output file received from the coupon card program manager 170. Although in this exemplary embodiment, the administrative computing system 160 and the authorization computing system 150 are separate computers, in alternative embodiments, one computer can be used to perform the functions of both the administrative computing system 160 and the authorization computing system 150.

The coupon card program manager 170 is, typically, the entity that is responsible for the coupon card 110 program, i.e., a particular manufacturer or franchise that is providing the incentive for the coupon cardholder 105 to purchase a particular product or a third party assigned with the task of administering a specific coupon card program. For example, the coupon card program manager 170 can be a candy manufacturer, whose product is sold at merchants. The coupon card 110, by capturing product-level data at the merchant point of sale 115 and processing this data at the authorization engine 143, can provide an incentive to the coupon cardholder 105 to purchase this particular brand of candy at certain merchants. These incentives may be provided to loyal customers as a reward and the level of the incentive may vary by how loyal a customer is. The coupon card program manager 170 can determine authorization controls for the coupon card 110 program, which define how much the discount will be for each incentive level, how often it can be applied, how long the card can be used, and other card parameters. These authorization controls will be described in more detail herein with reference to step 210 of FIG. 2.

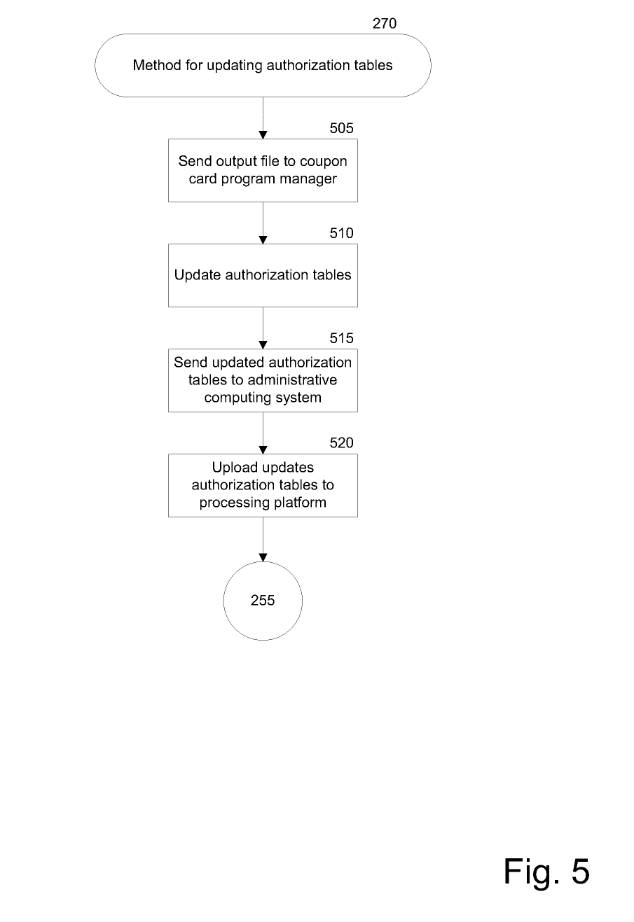

The coupon card program manager 170 also provides information for the authorization tables 145, by sending this information to the administrative computing system 160. For example, a declined transaction in the output file may have been declined because the SKU level data for the product was not found in the table. The coupon card program manager 170 can fill in any missing information and then send an updated authorization table back to the administrative computing system 160. The administrative computing system 160 can then update the authorization tables 145 in the processing platform 140. This process of building and updating the authorization tables will be described in more detail herein with reference to steps 215 and 260-270 of FIG. 2 and FIG. 5.

FIG. 2 is an overall process flow diagram depicting a method 200 for providing a product-based coupon card account in accordance with an exemplary embodiment of the present invention. Referring to FIGS. 1 and 2, the method 200 for providing a product-level coupon card 115 can be described. FIGS. 3, 4, and 5, discussed in detail below, provide additional details of this overall process.

At step 205, a coupon card administrator configures the merchant point of sale 115, the association network 130, the authorization engine 143, and/or the acquirer 125 to capture and transfer product-level data. Conventional point of sale devices do not capture and send such data, and conventional coupon card processors do not analyze such data. Thus, the merchant point of sale 115, the association network 130, the authorization engine 143, and/or the acquirer 125 must be configured such that product-level data is placed in a predetermined data element in a data string. The data string is a compilation of data associated with the transaction and typically includes the coupon card 110 number, a merchant identifier, a transaction amount, and other information associated with the transaction, which is ultimately sent to the authorization engine 143 for approval analysis. To configure the data string to contain product-level data, a particular data element number, within the data string, is designated to contain such information. For example, the data element containing the product-level data can occupy data element number 93 or 104 of a data string. When the data string is received for analysis by the authorization engine 143, the product-level data is easily identifiable based on the predetermined data element. Thus, by designating, in advance of the transaction, a predetermined data string to contain the product-level data, each entity involved in processing the transaction can access, transfer, and analyze this data. The particular data string number can be different based on the association network 130, the coupon card program manager 170, or the merchant point of sale 115. Thus, different coupon card programs may require different configurations. In any event, the product-level data is captured and sent as a data element of a data string. The data element can include different combinations of product-level data, i.e. a SKU number; one or more UPC numbers; and/or another type of product data.

At step 210, the coupon card administrator configures the administrative computing system 160 based on the authorization controls determined by the coupon card program manager 170. As discussed above, the authorization controls for the coupon card program define how much the discount will be for coupon cards 110, how often it can be applied, how long the card can be used, and other card parameters. The administrative computing system 160 can update the coupon cards 110 in the coupon card program based on these authorization controls.

The authorization controls allow the coupon card program manager 170 to customize the coupon card program to optimize the results of the program. The coupon card program may be seasonal and thus, the time period for using the coupon cards 110 can be set based on this season. Also, the coupon card program could include different incentive levels for the coupon cardholders 105, based on characteristics of the coupon cardholder 105, including the number of purchases of a particular product, the quantity of the product purchased over a given time period, and/or the frequency of which the coupon card 110 is used. The discount and/or incentive amount applied to the card and the frequency at which the incentive is applied to the coupon card 110 can vary based on the incentive levels.

The coupon card program can also be a simple, one-time use coupon card program. In this example, the authorization controls can be configured to allow only one use of the coupon card 110 with no further application of the discount and/or incentive to the coupon card 110.

At step 215, the coupon card program manager 170 builds the authorization tables 145. As discussed above with reference to FIG. 1, the authorization tables 145 are tables that store information related to the coupon card 110 accounts (that is, coupon card data), merchants having a merchant point of sale 115, and predetermined products for which incentives are given through the coupon card program. The coupon card program manager 170 sends the authorization tables 145 to the administrative computing system 160, which uploads them to the processing platform 140 of the authorizations computing system 150.

At step 220, the coupon card 110 is issued to the cardholder 105. The coupon card 110 can take the form of a credit card-like plastic card or a paper card. Alternatively, it can simply be an account number, where a physical card is not used. Thus, the coupon card 110 can be issued to the cardholder 105 in many different ways, including mail, electronic mail (e-mail), Internet website, and in-store distribution. The coupon card 110 can be issued inactive and include instructions for activating the coupon card 110, such as a phone number or a URL to an Internet website. After receiving the coupon card 110, the coupon cardholder 105 can activate the card using the instructions.

At step 225, the coupon card 110 is scanned at the merchant point of sale 115 during the process of a transaction. The term “scanned” is used herein to describe the process of capturing the coupon card 110 information and other transaction information during a transaction with a merchant. As discussed herein, the coupon card 110 may not be a card, but simply an account number. In that case, the transaction information and coupon card 110 number are simply entered into the merchant point of sale 115. Thus, at step 225, the merchant point of sale 115 captures product-level data for items in the transaction, information related to the coupon card 110, information associated with the merchant, such as a merchant identifier (“merchant ID”), as well as other information related to the transaction. This data, as discussed above with reference to step 205 of FIG. 2, is stored as a data string, the product-level data being stored in a predetermined data element of the data string. Upon scanning the coupon card 110, this data string is sent to the processing platform 140 for analysis, as described herein above with reference to FIG. 1.

At step 230, the transaction data (which is also referred to herein as the data string) is processed by the authorization engine 143 (which is a part of the processing platform 140) using the authorization tables 145. In short, the authorization engine 143 compares the data string related to the transaction, including the product-level data, to the information stored in the authorization tables 145. If the data string matches this data, then the transaction is approved. If it does not match this data, the transaction is declined. This approval process is described in more detail herein with reference to FIG. 3.

At step 235, if the authorization engine 143 determined that the transaction should be approved at step 230, the method 200 proceeds to step 240.

At step 240, the authorization engine 143, through the authorizations computing system 150, sends an approval message to the merchant point of sale 115. Upon receiving the approval message, the merchant can then complete the transaction with the discount and/or incentive provided by the coupon card 110.

At step 245, the authorization engine 143 sends the transaction data associated with the approved transaction to the administrative computing system 160 and the administrative computing system 160 stores this transaction data in a merchant retailer file. The administrative computing system 160 can periodically (e.g., daily or weekly) send the merchant retailer file to the coupon card program manager 170.

At step 250, after receiving the merchant retailer file, the coupon card program manager 170 settles the approved transaction and any other approved transactions in the merchant retailer file with the merchants at which the approved transactions took place.

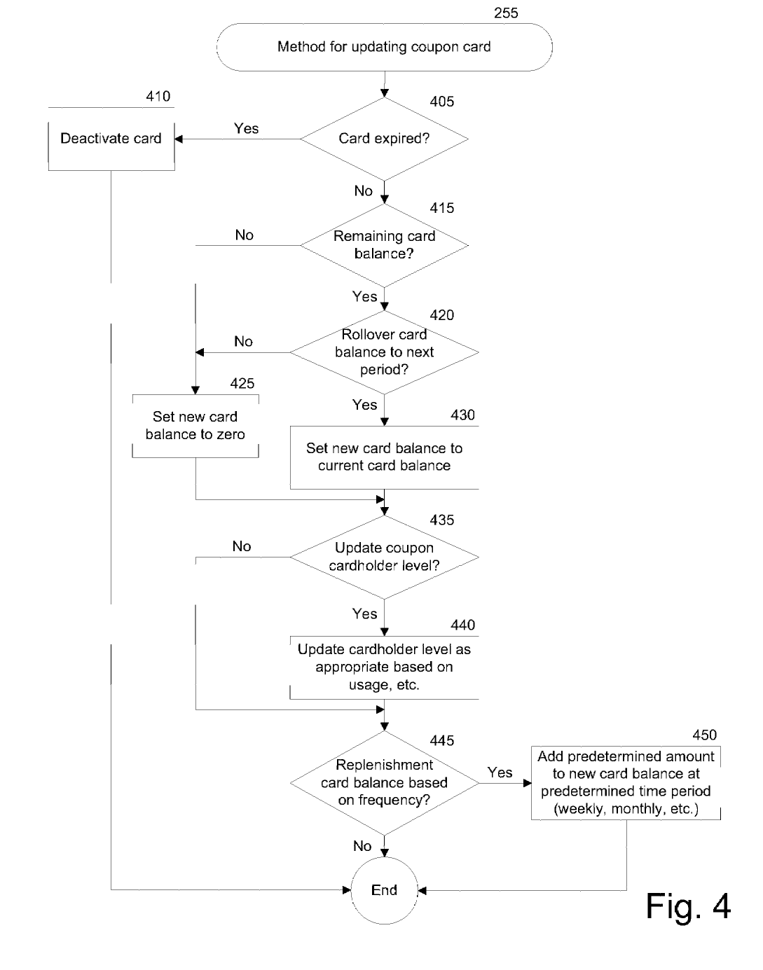

At step 255, the administrative computing system 160 updates the coupon card 110. Updating the coupon card 110 can include, for example, assessing the balance of the coupon card 110 and replenishing its balance as needed and determining whether the coupon card 110 is still active. Although this step 255 is illustrated as occurring after steps 250 and 270 (i.e., after each attempted transaction), this step 255 can occur at anytime as defined by the configuration of the coupon card program. For example, the coupon card 110 may be updated periodically based on the period for replenishing the balance of the coupon card 110. The processing of updating the coupon card 110 is described in more detail herein with reference to FIG. 4.

Referring back to step 235, if the authorization engine 143 makes the determination not to approve the transaction at step 230, the method 200 proceeds to step 260.

At step 260, the authorization engine 143, through the authorizations computing system 150, sends a decline message to the merchant point of sale 115. Upon receiving the decline message, the merchant is prevented from completing the transaction with the discount and/or incentive provided by the coupon card 110.

At step 265, the authorization engine 143 stores the declined transaction information in an output file. The authorization engine 143 is part of the authorizations computing system 150, which is in communication with the administrative computing system 160, which stores the output file.

At step 270, the coupon card program manager 170 and the administrative computing system 160 can work to update the authorization tables 145 based on declined transactions. For example, a transaction may be declined because a merchant has not been approved for using the coupon card 110. In this example, the coupon card program manager 170 may decide that the merchant should be approved and thus, adds the merchant to the authorization tables by associating a merchant ID with the merchant in the authorization tables. To accomplish this update, the administrative computing system 160 sends the output file containing the declined transactions to the coupon card program manager 170. The coupon card program manager 170 updates the authorization tables 145 and send the updated authorization tables 145 to the administrative computing system 160. The administrative computing system 160 then uploads the updated authorization tables 145 to the processing platform 140. This step 270 of updating the authorization tables 145 is discussed in more detail with reference to FIG. 5.

FIG. 3 is a detailed process flow diagram depicting a method 230 for processing transaction data using authorization tables 145 in accordance with an exemplary embodiment of the present invention. Referring to FIGS. 1 and 3, the method 230 for processing transaction data using authorization tables 145 can be described. The steps illustrated and discussed herein with reference to FIG. 3 represent a series of queries wherein the authorization engine 143 assesses whether the transaction data (data string) exists in the authorization tables 145. FIG. 3 is exemplary, and in certain embodiments, more or less queries, and/or different queries may be used and in a different order.

At step 305, the authorization engine 143 accesses the authorization tables 145. The authorization tables 145 can reside on the processing platform 140, as part of the authorization engine 143, or the authorization tables 145 can reside in an authorization tables database 147. As discussed above with reference to FIG. 1, the authorization tables 145 are tables which store information related to the coupon card 110 accounts, merchants having a merchant point of sale 115, and predetermined products for which incentives are given through the coupon card program.

At step 310, the authorization engine 143 searches the authorization tables 145 for the coupon card number. The coupon card number is the account number associated with the coupon card 110 and is contained in the transaction data received by the authorization engine 143 at step 225 of FIG. 2.

If, at step 315, the authorization engine 143 determines that the coupon card number is found in the authorization tables 145, the method 230 proceeds to step 320 for additional queries. Otherwise, the method 230 proceeds to step 345.

At step 320, the authorization engine 143 searches the authorization tables 145 for the merchant ID contained in the transaction data. The merchant ID is an identifier associated with the merchant at which the transaction is taking place. The coupon card 110 may be active at certain merchants only. Thus, the transaction will be approved only if the Merchant ID is found in the authorization tables 145.

If, at step 325, the authorization engine 143 determines that the merchant ID is found in the authorization tables 145, the method 230 proceeds to step 330 for additional queries. Otherwise, the method 230 proceeds to step 345.

At step 330, the authorization engine 143 searches the authorization tables 145 for the product-level data (e.g., SKU or UPC data) contained in the transaction data for the product being purchased. As discussed above, the coupon card 110 is used to provide an incentive to purchase a predetermined product. Thus, the transaction will be approved only if this predetermined product is being purchased as indicated in the transaction data.

If, at step 335, the authorization engine 143 determines that the product-level data is found in the authorization tables 145, the method 230 proceeds to step 340 for additional queries. Otherwise, the method 230 proceeds to step 345.

At step 340, the authorization engine 143 looks up the expiration date for the coupon card 110 and determines if the coupon card 110 has expired. The coupon card program manager 170 can define a set time period for a coupon cardholder 105 to have access to the benefits of the coupon card 110. Once this time period expires, the coupon card 110 can not be used.

If, at step 350, the authorization engine 143 determines that the coupon card 110 has not expired, the method 230 proceeds to step 355 for additional queries. Otherwise, the method 230 proceeds to step 345.

At step 355, the authorization engine 143 determines if a personal identification number (PIN) in the transaction data matches the PIN for the coupon card 110 in the authorization tables 145. Although in this exemplary embodiment, a PIN is associated with each coupon card 110, the PIN is optional for a coupon card program. This PIN can be the same for each coupon card 110 in a coupon card program or can vary from coupon card 110 to coupon card 110. Additionally, in some exemplary embodiments, the PIN for a coupon card 110 can be set and modified by the coupon cardholder 105. The PIN can be entered by the coupon cardholder 105 at the merchant point of sale 115 (similar to a debit card PIN) and the merchant point of sale 115 can include this PIN with the transaction data.

If, at step 360, the authorization engine 143 determines that the PIN in the transaction data matches the PIN for the coupon card 110 in the authorization tables 145, the method 230 proceeds to step 365 for additional queries. Otherwise, the method 230 proceeds to step 345.

At step 365, the authorization engine 143 determines if the coupon card 110 has an adequate balance for the transaction. As briefly described above, the coupon card program manager 170 can define the amount of discount and how often the discount can be applied in the authorization controls. For example, the coupon card program manager 170 can define a $2 off coupon to be applied to the coupon card 110 once a week for the coupon cardholder to use. The coupon card program manager 170 can also specify that the entire $2 has to be applied in one transaction for one unit of the predetermined product or that the $2 has to be applied as two separate $1 discounts associated with the purchase of two units of the predetermined product. After the coupon cardholder 105 has used the coupon card 110 and depleted the balance, the coupon card 110 can not be used again until the balance of the coupon card 110 is updated for the next period.

If, at step 370, the authorization engine 143 determines that the balance of the coupon card 110 is adequate, the method 230 proceeds to step 375 for an additional query. Otherwise, the method 230 proceeds to step 345.

At step 375, the authorization engine 143 looks up the status of the coupon card 110. In one exemplary embodiment, the coupon card 110 can have a status of active, inactive, and blocked. As discussed above, the coupon card 110 can be issued inactive and can be activated by the coupon cardholder 105. Additionally, if the coupon cardholder 105 loses or has the coupon card 110 stolen, the coupon cardholder 105 can report this and the status of the coupon card can be updated to blocked. This blocked status prevents the coupon card 105 from being used until the coupon card 110 is found. If the coupon card is not found, a new coupon card 110 having a new card number can be issued to the coupon cardholder 105.

If, at step 380, the authorization engine 143 determines that the status of the coupon card 110 is active and not blocked or inactive, the method 230 proceeds to step 385. Otherwise, the method 230 proceeds to step 345.

At step 345, the authorization engine 143 determines that the transaction should be declined as the transaction data failed to satisfy at least one query. The method 230 then proceeds to step 235 of FIG. 2.

At step 385, the authorization engine 143 determines that the transaction should be approved as the transaction data satisfied each query. The authorization engine 143 communicates information associated with the approved transaction to the administrative computing system 160 so that the administrative computing system 160 can update the balance of the coupon card 110 in the authorization tables 145.

FIG. 4 is a detailed process flow diagram depicting a method 255 for updating a coupon card 110 in accordance with an exemplary embodiment of the present invention. Referring to FIGS. 1 and 4, the method 255 for updating a coupon card 110 can be described.

At step 405, the administrative computing system 160 determines if the coupon card 110 has expired by examining the expiration date of the coupon card 110 in the authorization tables 145. If the coupon card 110 has expired, the method 255 proceeds to step 410. Otherwise, the method 255 proceeds to step 415.

At step 410, the administrative computing system 160 deactivates the coupon card 110. In one exemplary embodiment, the administrative computing system 160 removes the information associated with the deactivated coupon card 110 from the authorization tables 145. In another exemplary embodiment, the administrative computing system 160 updates the status of the coupon card 110 to inactive in the authorization tables 145.

At step 415, the administrative computing system 160 checks the authorization tables 145 to determine if coupon card 110 has a balance remaining. If the coupon card 110 has a remaining balance, the method 255 proceeds to step 420. Otherwise, the method 255 proceeds to step 425.

At step 420, the administrative computing system 160 determines, based on the authorization controls, whether the remaining balance should be “rolled over” to the next period. In some coupon card programs, the coupon card program manager 170 may allow for remaining balances to roll over to the next period for use by the coupon cardholder 105. In other coupon card programs, the coupon card program manager 170 may limit the use of any incentive to a pre-defined period, and thus, not allow for balance rollover. Or, in yet another coupon card program, the coupon cards 110 may be issued for one-time use and thus, there would not be any balance rollover. If balance rollover is allowed, the method 255 proceeds to step 430. Otherwise, the method 255 proceeds to step 425.

At step 425, the administrative computing system 160 sets the balance of the coupon card 110 to zero in the authorization tables 145. The method 255 then proceeds to step 435.

At step 430, the administrative computing system 160 sets the new card balance of the coupon card 110 to the current balance of the coupon card 110 in the authorization tables 145, thus rolling over the remaining balance.

At step 435, the administrative computing system 160 determines if the coupon cardholder level should be updated. As discussed above, coupon cards 110 can be issued with different incentive levels. For example, there may be a $1 per week incentive level and a $5 per week incentive level. The incentive level can be determined based on many characteristics of the coupon cardholder 105, including the number of purchases of a particular product, the quantity of the product purchased over a given time period, or the frequency of which the coupon card 110 is used. If the administrative computing system 160 determines that the incentive level of the coupon cardholder should be updated, the method 255 proceeds to step 440 to update the coupon cardholder 105 incentive level in the authorization tables 145. Otherwise, the method 255 proceeds to step 445.

At step 440, the administrative computing system 160 updates the coupon cardholder 105 incentive level in the authorization tables 145 based on the determination made at step 435.

At step 445, the administrative computing system 160 determines based on the authorization controls, if the balance of the coupon card 110 should be updated based on a frequency (e.g., weekly, monthly, etc.) and if the time period of that frequency has expired. As discussed above, the coupon card program manager 170 can specify a frequency for which to replenish the balance of a coupon card 110. If the time period associated with the frequency has expired, the method 255 proceeds to step 450. Otherwise, the method 255 ends.

At step 450, the administrative computing system 160 adds the predetermined incentive amount to the coupon card 110. If the coupon card program has different incentive levels, the predetermined incentive amount added to the coupon card is based on the incentive level of the coupon cardholder 105. After the incentive amount has been added to the coupon card 110, the method 255 ends.

FIG. 5 is a detailed process flow diagram depicting a method 270 for updating authorization tables in accordance with an exemplary embodiment of the present invention. Referring to FIGS. 1 and 5, the method 270 for updating a coupon card 110 can be described.

At step 505, the administrative computing system 160 sends the output file containing the declined transaction information to the coupon card program manager 170.

At step 510, the coupon card program manager 170 examines the output file to determine if any of the declined transactions contained in the output file should be approved in the future, and if so updates the information in the authorization tables 145 so that future transactions with similar transaction information will be approved.

At step 515, the coupon card program manager 170 sends the updated authorization tables 145 to the administrative computing system 160.

At step 520, the administrative computing system 160 receives the updated authorization tables 145 from the coupon card program manager 170 and uploads the updated authorization tables 145 to the authorization computing system 150. After the authorization tables 145 have been updated, the authorization computing system 150 can save the authorization tables 145 to a storage location on the authorization computing system 150 or to the authorization tables database 147. The method 270 then proceeds to step 250 of FIG. 2.

One of ordinary skill in the art would appreciate that the invention provides systems and methods for providing a product-based coupon account. Specifically, the invention provides systems and methods for providing consumers with a coupon account for receiving an incentive or discount for purchasing a particular product. The consumer is issued a coupon account or coupon card that can be used at a merchant to receive the incentive at the time of purchase of the particular product. The coupon card is scanned at the merchant point of sale and information associated with the transaction including product-level information (e.g., SKU or UPC) and information associated with the coupon card is communicated to a authorization computing system for approval based on this information. The coupon card can be issued for one-time use or can receive updated incentives periodically.

What is claimed:

1. A method for providing a product-based coupon account comprising the steps of:
receiving, by a processing platform, a data element comprising transaction data associated with a transaction, the transaction data comprising product data associated with a product in the transaction and coupon card data;
determining, by an authorization engine, whether the transaction is approved by comparing the data element to information stored in an authorization table; and
in response to determining, by the authorization engine, that the transaction is approved, sending an approval message to the merchant indicating that a discount can be applied to the transaction.

2. The method of claim 1, wherein the product data comprises at least one of a Stock-Keeping Unit (SKU) and a Universal Product Code (UPC) identifier associated with the item.

3. The method of claim 1, further comprising the steps of scanning a coupon card associated with the product-based coupon account.

4. The method of claim 1, wherein the transaction data further comprises merchant identification data.

5. The method of claim 1, wherein the information stored in the authorization table comprises at least one of: product data associated with the product; coupon card data; and merchant identification data.

6. The method of claim 1, wherein the step of comparing the data element associated with the product to information stored in the authorization table further comprises:
comparing a merchant ID in the authorization table to a merchant ID associated with the merchant;
comparing product data in the authorization table to the product data associated with the product; and
comparing an account number in the authorization table with an account number associated with the coupon card.

7. The method of claim 1, wherein information associated with an approved transaction is stored by a computing system and is used to settle a financial obligation of the discount with the merchant.

8. The method of claim 1, wherein information associated with a transaction that is not approved is stored by a computing system.

9. The method of claim 1, further comprising updating a balance of discounts available on the product-based coupon account.

10. The method of claim 9, wherein the balance is updated periodically.

11. The method of claim 9, wherein an amount of the balance is determined based on an incentive level associated with the coupon account.

12. The method of claim 1, further comprising the step of updating the authorization table, wherein the updating steps comprise:
storing information associated with a declined transaction in an output table; and
updating the authorization table based on the information in the output table.

13. The method of claim 1, wherein the data element is received at the processing platform from an association network.

14. A system for providing a product-based coupon account, comprising:
a computing system communicably coupled to a merchant point of sale, the computing system comprising an authorization engine for determining whether a transaction is approved, the communications between the computing system and merchant point of sale comprising:
receiving a data element, at the computing system, comprising transaction data associated with a transaction, the transaction data comprising product data associated with a product in the transaction and coupon card data; and
in response to determining, by the authorization engine, that the transaction is approved, sending, by the computing system, an approval message to the merchant point of sale indicating that a discount can be applied to the transaction,
wherein the authorization engine determines whether the transaction is approved by comparing the transaction data to information stored in an authorization table.

15. The system of claim 14, wherein the product data comprises at least one of a Stock-Keeping Unit (SKU) and a Universal Product Code (UPC) identifier associated with the item.

16. The system of claim 14, wherein the transaction data further comprises merchant identification data.

17. The system of claim 14, wherein the information stored in the authorization table comprises at least one of: product data associated with the product; coupon card data; and merchant identification data.

18. The system of claim 14, wherein the computing system is communicably coupled to a data store for storing one or more authorization tables and files comprising data associated with transactions processed by the authorization engine.

19. The system of claim 14, further comprising an association network for communicating the data element from the merchant point of sale to the computing system and for communicating the approval message from the computing system to the merchant point of sale.

20. The system of claim 14, further comprising a card operable to be scanned at a merchant point of sale device to capture the coupon card data.
